(19) United States
(12) Patent Application Publication
(10) Pub. No.: US 2023/0273965 A1
(43) Pub. Date: Aug. 31, 2023

(54) Systems And Methods For Comparing Data Sets For Sporting Equipment

(71) Applicant: ShredMetrix LLC, Melbourne, FL (US)

(72) Inventors: Jared McNally, Basalt, CO (US); Kammie Melton, Basalt, CO (US); Michael Lee, Culver City, CA (US)

(21) Appl. No.: 17/681,244

(22) Filed: Feb. 25, 2022

(51) Int. Cl. G06F 16/9538; G06F 16/9535

(52) U.S. Cl. CPC G06F 16/9538; G06F 16/9535

(57) ABSTRACT

A sporting equipment apparatus is described. The apparatus including a sporting equipment data aggregation module configured to receive a plurality of data sets for a plurality of pieces of sporting equipment, each set including sporting equipment parameters for a piece of sporting equipment. The apparatus also including a user interface module configured to receive input of a user requested data set of requested sporting equipment parameters. The apparatus also including a sporting equipment analysis module configured to: compare the user requested data set to the plurality of data sets and select at least one piece of sporting equipment based on a comparison of the user requested data set to the plurality of data sets. The user interface module is configured to generate for display at least one image of the at least one piece of sporting equipment presented to a user.

### TECHNICAL FIELD

United States Patent Classification (USPC) class/subclass 707/706 (DATA PROCESSING: DATABASE, DATA MINING, AND FILE MANAGEMENT OR DATA STRUCTURES—relating to programs which enable an end user to query unstructured, semi-structured or structured documents that have been indexed, categorized or organized).

The present disclosure relates generally to systems and methods for analyzing and comparing data sets for sporting equipment.

### BACKGROUND

Extreme sports, such as snowboarding and skiing, require expensive and unique sporting equipment that is available in various shapes and sizes. This sporting equipment is often tailored to the user/rider along with the setting of the sporting activity. For example, snowboards are available in different lengths, widths, and profiles among other variables which affect the efficacy of the snowboard in different terrains while ridden by users of specific heights, weights, and skill levels. Since these variables each affect how compatible the sporting equipment is for the user and their intended activity, it can be useful for a user to be able to compare different sporting equipment options prior to purchase.

Currently, systems and methods are available which allow a user to compare data sets such as the outer profiles of two sporting equipment options (e.g. surfboards) on top of one another. Other systems are available which allow a user to view a list of specifications for a selected sporting equipment. However, none of the currently available systems/methods allow a user to compare the profiles of two or more sporting equipment options side-by-side in multiple perspectives. In addition, the available systems/methods lack the option to compare the profiles of two or more sporting equipment options along with the specifications of the sporting equipment options all at once. As such, a sporting equipment system that helps a user analyze, visualize, and compare sporting equipment without the aforementioned deficiencies is desirable.

### SUMMARY

In a feature, a sporting equipment apparatus for comparing data sets is described. The sporting equipment apparatus includes a sporting equipment data aggregation module configured to receive a plurality of data sets for a plurality of pieces of sporting equipment, each set of the plurality of data sets including sporting equipment parameters for a piece of sporting equipment of the plurality of pieces of sporting equipment. The sporting equipment apparatus also includes a user interface module configured to receive input of a user requested data set including one or more requested sporting equipment parameters. The sporting equipment apparatus also includes a sporting equipment analysis module configured to: compare the user requested data set to the plurality of data sets; and select at least one piece of sporting equipment from the plurality of pieces of sporting equipment based on a comparison of the user requested data set to the plurality of data sets. The user interface module is configured to generate for display at least one image of the at least one piece of sporting equipment presented to a user.

In further features, the user interface module is configured to generate for display the at least one image of the at least one piece of sporting equipment via a graphical user interface, the graphical user interface including a plurality of sections including an equipment visualizer, a specification viewer, an equipment browser, and a control manager.

In further features, the at least one piece of sporting equipment is further defined as a first piece of sporting equipment, the at least one image of the at least one piece of sporting equipment is further defined as a first picture, the sporting equipment analysis module is configured to select a second piece of sporting equipment and a third piece of sporting equipment based on the comparison of the user requested data set to the plurality of data sets.

In further features, the user interface module is configured to generate for display the first picture of the first piece of sporting equipment, a second picture of the second piece of sporting equipment, and a third picture of the third piece of sporting equipment in the equipment browser.

In further features, the user interface module is configured to generate for display the first picture of the first piece of sporting equipment, the second picture of the second piece of sporting equipment, and the third picture of the third piece of sporting equipment in the equipment browser in a hierarchal order.

In further features, the hierarchal order is a descending hierarchal order in which the sporting equipment analysis module determines the descending hierarchal order based on a number of matching parameters for each of the first piece of sporting equipment, the second piece of sporting equipment, and the third piece of sporting equipment.

In further features, the user interface module is configured to generate for display in the equipment visualizer, a first shape of the first piece of sporting equipment in a first perspective or a second perspective in response to receiving a selection of the first piece of sporting equipment from the equipment browser.

In further features, the user interface module is configured to generate for display in the equipment visualizer, a second shape of the second piece of sporting equipment in the first perspective or the second perspective in response to receiving a selection of the second piece of sporting equipment from the equipment browser.

In further features, the user interface module is configured to concurrently generate for display in the equipment visualizer, the first shape of the first piece of sporting equipment in the first perspective or the second perspective in response to receiving the selection of the first piece of sporting equipment from the equipment browser and the second shape of the second piece of sporting equipment in the first perspective or the second perspective in response to receiving the selection of the second piece of sporting equipment from the equipment browser.

In further features, the user interface module is further configured to in response to user input, generate for display in the equipment visualizer, the first shape and the second shape in a collapsible view in at least one of the first perspective and the second perspective as to allow the user to make a relative comparison of the first shape and the second shape to each other in at least one of the first perspective and the second perspective.

In further features, in the collapsible view the first shape and the second shape are displayed overlapping each other.

In further features, the one or more requested sporting equipment parameters includes at least one of a turning radius, an aggression, a turn initiation, a speed, a float, a butterability, a carvability, a chunderability, and an impact absorption.

In further features, a method for comparing data sets of sports equipment is described. The method including receiving a plurality of data sets for a plurality of pieces of sporting equipment, each set of the plurality of data sets including sporting equipment parameters for a piece of sporting equipment of the plurality of pieces of sporting equipment. The method further including receiving input of a user requested data set including one or more requested sporting equipment parameters. The method further including comparing the user requested data set to the plurality of data sets. The method further including selecting at least one piece of sporting equipment from the plurality of pieces of sporting equipment based on a comparison of the user requested data set to the plurality of data sets. The method further including generating for display at least one image of the at least one piece of sporting equipment presented to a user by way of a graphical user interface.

In further features, the graphical user interface includes a plurality of sections including an equipment visualizer, a specification viewer, an equipment browser, and a control manager.

In further features, the at least one piece of sporting equipment is further defined as a first piece of sporting equipment, the at least one image of the at least one piece of sporting equipment is further defined as a first picture, the method further comprises selecting a second piece of sporting equipment and a third piece of sporting equipment based on the comparison of the user requested data set to the plurality of data sets.

In further features, the method includes generating for display the first picture of the first piece of sporting equipment, a second picture of the second piece of sporting equipment, and a third picture of the third piece of sporting equipment in the equipment browser.

In further features, the method includes generating for display the first picture of the first piece of sporting equipment, the second picture of the second piece of sporting equipment, and the third picture of the third piece of sporting equipment in the equipment browser in a hierarchal order.

In further features, the hierarchal order is a descending hierarchal order. The method includes determining a descending hierarchal order based on a number of matching parameters for each of the first piece of sporting equipment, the second piece of sporting equipment, and the third piece of sporting equipment.

In further features, the method includes generating for display in the equipment visualizer, a first shape of the first piece of sporting equipment in a first perspective or a second perspective in response to receiving a selection of the first piece of sporting equipment from the equipment browser.

In a feature, a non-transitory computer-readable medium storing processor-executable instructions is described. The processor-executable instructions including receiving a plurality of data sets for a plurality of pieces of sporting equipment, each set of the plurality of data sets including sporting equipment parameters for a piece of sporting equipment of the plurality of pieces of sporting equipment. The processor-executable instructions further including receiving input of a user requested data set including one or more requested sporting equipment parameters. The processor-executable instructions further including comparing the user requested data set to the plurality of data sets. The method further including selecting at least one piece of sporting equipment from the plurality of pieces of sporting equipment based on a comparison of the user requested data set to the plurality of data sets. The method further including generating for display at least one image of the at least one piece of sporting equipment presented to a user by way of a graphical user interface.

### BRIEF DESCRIPTION OF THE DRAWINGS

Advantages of the present invention will be readily appreciated as the same becomes better understood by reference to the following detailed description when considered in connection with the accompanying drawings.

FIG. 1 is a network environment of a sporting equipment system, according to the teachings of the present disclosure.

FIG. 2 is a block diagram of the sporting equipment system, according to the teachings of the present disclosure.

FIG. 3 is a graphical user interface of the sporting equipment system, according to the teachings of the present disclosure.

FIG. 4 is an example graphical user interface of the sporting equipment system for comparing and analyzing snowboards, according to the teachings of the present disclosure.

FIG. 5 is an example graphical user interface of the sporting equipment system for searching through snowboards, according to the teachings of the present disclosure.

FIGS. 6A-6B are examples of rider avatars and sporting equipment created and shown by the sporting equipment system, according to the teachings of the present disclosure.

FIGS. 7A-7D are various example graphical user interfaces of the sporting equipment system, according to the teachings of the present disclosure.

FIGS. 8-10 are flowcharts illustrating methods of implementing the sporting equipment system, according to the teachings of the present disclosure.

### DETAILED DESCRIPTION

Referring to the Figures, wherein like numerals indicate like or corresponding parts throughout the several views, a sporting equipment system 100 and method for operating the same are shown throughout.

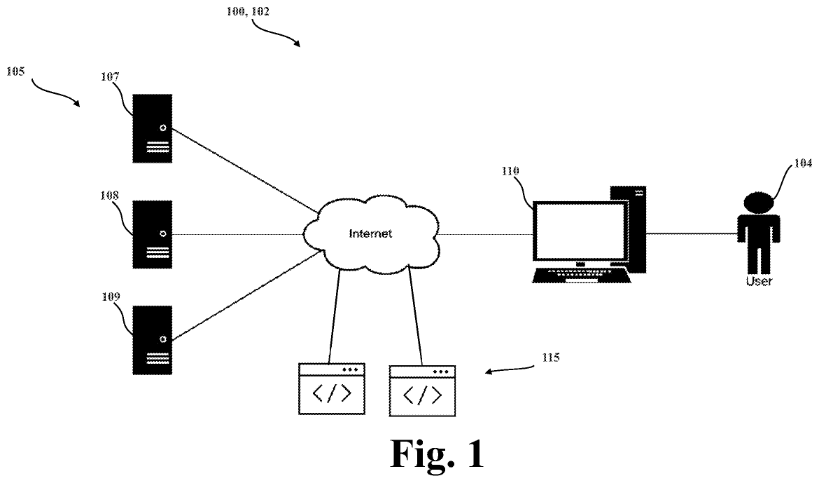

Referring to FIG. 1, the sporting equipment system 100 and a corresponding network environment 102 is illustrated. The sporting equipment system 100 presents the user with an interactive web application that allows a user 104 to analyze and compare sporting equipment. As shown in FIG. 1, the network environment 102 includes one or more servers 105 running the interactive web application, the one or more servers 105 may include an application server 107, a database server 108 (herein “the database”), and a web server 109. While the application server 107, the database server 108, and the web server 109 ae shown as separate servers, the functionality of each of the servers may be performed by a single server.

The network environment also includes a user computing device 110 and one or more data sources 115. The one or more servers 105 and the user computing device 110 are connected to one another over the internet. The user is thus able to access the sporting equipment system 100 by using the user computing device 110 while connected to the internet. The user computing device 110 could be, for example, a desktop computer, a laptop computer, a mobile device (e.g., assuming a handheld configuration such as a tablet or mobile phone), a wearable device, or any other suitable device. As such, suitable devices may range from full resource devices with substantial memory and processor resources (e.g., personal computers, game consoles) to low-resource devices with limited memory and/or processing resources (e.g., wearable devices).

It will be understood that although the remainder of the present description describes and provides illustrated embodiments of the sporting equipment as a snowboard 106, such as the first and second snowboards 106A, 106B, the sporting equipment system 100 may be utilized with any suitable sporting equipment, in particular, boardsport sporting equipment. Examples of boardsports include skies, snow skates, snowshoes, surfboards, skateboards, longboards, wakeboards, surf skates, wake surfboards, kiteboards, and paddleboards.

The sporting equipment system 100 presents an interactive web application including one or more graphical user interfaces (GUIs) to the user 104 at the computing device 110. The user 104 is able to retrieve data stored in the database 108 of the interactive web application, pertaining to snowboards 106 of interest. As described in more detail below, the sporting equipment system 100 allows the user 104 to retrieve data from the database 108, the data including one or more images, a plurality of snowboard parameters and/or snowboard specification sets specific to a plurality of snowboard. The snowboard parameters are generally related to the shape and profile of the snowboard. Once retrieved, data specific to a first snowboard 106A can be compared to data specific to a second snowboard 106B to help the user 104 understand the differences between the first and second snowboards 106A, 106B.

The snowboard specification sets may include at least one of a length of the snowboard, a taper of the snowboard, a tip width of the snowboard, a waist width of the snowboard, a contour of the snowboard, a minimum setback of the snowboard, a maximum setback of the snowboard, a recommended setback of the snowboard, a material of the snowboard, a stiffness of the snowboard, an axial stiffness of the snowboard, a torsional stiffness of the snowboard, a durability of the snowboard, a porosity of the snowboard, a weight of the snowboard, a density of the snowboard, a volume of the snowboard, a surface area of the snowboard, and a sidecut of the snowboard.

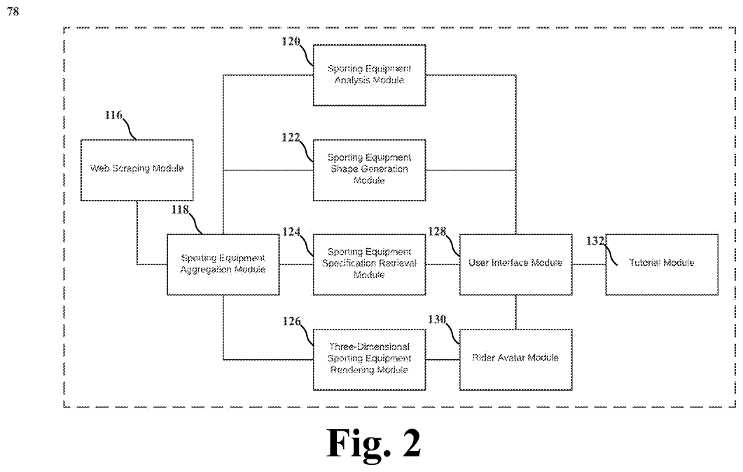

Referring to FIG. 2, a block diagram of the sporting equipment system 100 is illustrated. The sporting equipment system 100 includes a web scraping module 116, a sporting equipment aggregation module 118, a sporting equipment analysis module 120, a sporting equipment shape generation module 122, a sporting equipment specification retrieval module 124, a three-dimensional sporting equipment rendering module 126, a user interface module 128, a rider avatar module 130, and a tutorial module 132. The user 104 may interact with the sporting equipment system 100 via one or more graphical user interfaces (GUIs) presented to the user by the user interface module 128. As can be appreciated from the figures, the user interface module 128 is directly and indirectly connected to each of the other modules of the sporting equipment system 100. Although specific modules are shown in direct connection with other modules and in indirect connection with further modules, it is further contemplated that these connections could be otherwise different as long as the sporting equipment system 100 is still able to perform the functions described below. For example, the sporting equipment aggregation module 118 is shown in direct connection with the web scraping module 116 and the sporting equipment specification retrieval module 124; however, it is possible for the user interface module 128 to interact with the sporting equipment aggregation module 118 without interference from the sporting equipment specification retrieval module 124. In other words, any indirect connection between modules can otherwise be understood to be a direct connection.

The sporting equipment system 100 gathers snowboards 106 from various different data sources 115 (e.g., a snowboard manufacturer) in order to present the user with a large variety of snowboards 106 to choose from. Although the disclosure contemplates the data sources 115 as a snowboard manufacturer, the data sources may include any third party provider of information, for example, an external database, a website, a catalog, etc. The sporting equipment system 100 may gather snowboard parameters, images, and specification sets from the various data sources, via the web scraping module 116. The web scraping module 116 may be configured to extract the snowboard parameters and specification sets from existing data sources 115 and store the information in the database 108. For example, the web scraping may be performed on a particular snowboard manufacturers website once every month. The web scraping module 116 may be configured to parse the data so that the data is in an acceptable format for the database 108. The web scraping module 116 may perform a method similar to that disclosed by U.S. Pat. No. 10,210,255, entitled, “Distributed System for Large Volume Deep Web Data Extraction,” the disclosure of which is hereby incorporated by reference. Although the example is provided that the web scraping module 116 may performs the web scraping itself, the web scraping module 116 may receive the snowboards 106 and corresponding parameters and specification sets from an external web scraping application/program. Other methods of web scraping are also contemplated.

The sporting equipment system 100 may be configured to, in place or in addition to the web scrape module 116, receive input from a data custodian of sporting equipment system 100 into the database 108 or receive the snowboard and corresponding parameters from a physical measuring device (not shown). The physical measuring device may include an optical sensor or an optical sensor. For example, the optical sensor or the optical scanner may be similar to that disclosed in U.S. Pat. No. 8,810,778 or German Patent 202012104175U1, the contents which are hereby incorporated by reference in their entireties. The physical measuring device may provide one or more measurements (e.g., length, width, thickness, etc.) of the snowboard or convert a snowboard into a two-dimensional and/or three-dimensional model for entry into the database 108.

The sporting equipment aggregation module 118 may be configured to query the database 108 to generate a report of all data currently in the database 108. The sporting equipment aggregation module 118 may be configured to compare the data provided by the web scraping module 116 in order to determine which data is already stored in the database 108 and may therefore be disregarded and which portion of the data is not currently stored in the database and therefore needs to be stored into the database 108.

The sporting equipment system 100 may further include the sporting equipment specification retrieval module 124 configured to retrieve the specification sets from the database 108. Similar to the parameters, the specification sets may be presented to the user 104 by the user interface module 128 in response to a user request. In addition to presenting the information (e.g. parameters and specification sets directly to the user 104 with the user interface module 128), the parameters and specification sets may be utilized by the sporting equipment shape generation module 122 and the sporting equipment analysis module 120, respectively.

The sporting equipment shape generation module 122 is configured to determine a shape of the snowboard based on the parameters received from the sporting equipment aggregation module 118. The shape of the snowboard generally includes the dimensions/profile of the snowboard. As described in more detail below, the user interface module 128 may present to the user various snowboards 106 so that the user 104 may make a relative comparison (e.g., side-by-side comparison) of the snowboards 106.

The sporting equipment analysis module 120 is configured to compare a requested parameter and/or specification set to the parameters and/or specification sets of the snowboards 106 stored on the database 108, and to select at least one snowboard based on the comparison. This allows a more tailored list of snowboards 106 to be presented to the user 104. For example, the user 104 may desire to look at snowboards 106 of a certain price, suggested ability level, and length. By comparing the prices, suggested ability levels, and lengths of the snowboards 106 stored on the database 108 against the price, suggested ability level, and length desired by the user 104, the sporting equipment system 100 may present snowboards 106 to the user 104 which are potentially desired by the user 104.

The sporting analysis module 138 may also be configured based on user input to generate a collapsible view of snowboards 106 displayed to the user. For example, when the user interface module 128 is displaying two snowboards 106 to the user 104, in response to user input, the sporting equipment comparison module 138 may generate the collapsible view of the snowboards 106 where the snowboards 106 are displayed overlapping each other, so the user 104 can make a relative comparison of the snowboards 106.

Further, the sporting equipment system 100 may include the three-dimensional sporting equipment rendering module 126 configured to generate a three-dimensional (3D) model of the snowboard 106. The sporting equipment system 100 may also include a rider avatar module 130 configured to generate a three-dimensional rider avatar 134 based on a received set of rider characteristics from the user 104. The rider avatar module 130 may generate a new avatar or may select a closest match from a plurality of preconfigured avatars. The three-dimensional model of the snowboard 106 and the three-dimensional rider avatar 134 are then able to be utilized together such that the rider avatar 134 is displayed proximate to the model of the snowboard by the user interface module 128. For example, the user interface module 128 may display the rider avatar 134 in a riding pose on top of the snowboard 106. The user 104 may thus input rider characteristics to the rider avatar module 130 that match the user 104 so that the user 104 can use the sporting equipment system 100 to model how the user 104 would look while riding the snowboard 106. Alternatively, the user interface module 128 could display the rider avatar 134 next to the model of the snowboard 106 so that the user 104 can see what they would look like next to the snowboard 106. Various other configurations are contemplated. The sporting equipment system 100 may employ systems and methods for generating the rider avatar similar to that disclosed by U.S. Patent Pub. No. 20140198121A1 and PCT Publication WO2018053449, the contents of both which are hereby incorporated by reference in their entireties.

In order to introduce new users 104 to the sporting equipment system 100, the system 100 may include the tutorial module 132. The tutorial module 132 may be configured to provide a series of instructions to the user via the user interface module 128 which help guide new users 104 through the system 100. For example, the tutorial module 132 may point to various features presented by the user interface module 128 (described below) to make the user 104 aware of each feature and how to use them.

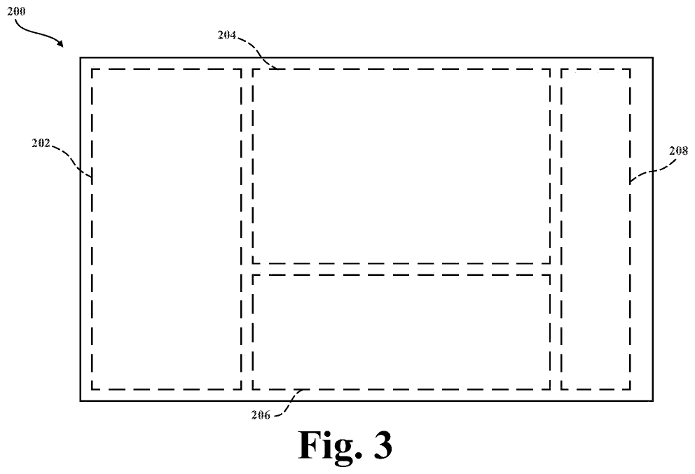

Referring to FIG. 3, an example graphical user interface (GUI) 200 of the sporting equipment system 100 is shown. The GUI 200 is controlled by the user interface module 128 and is utilized by the user 104 to interact with the system 100. The GUI 200 is also used to present the snowboard 106, snowboard parameters 112, snowboard specification sets 114, rider avatars 134, and models of the snowboard 106. FIG. 3 depicts four general sections of the GUI 200: an equipment browser section 202, an equipment visualizer section 204, a specification viewer section 206, and a control manager section 208.

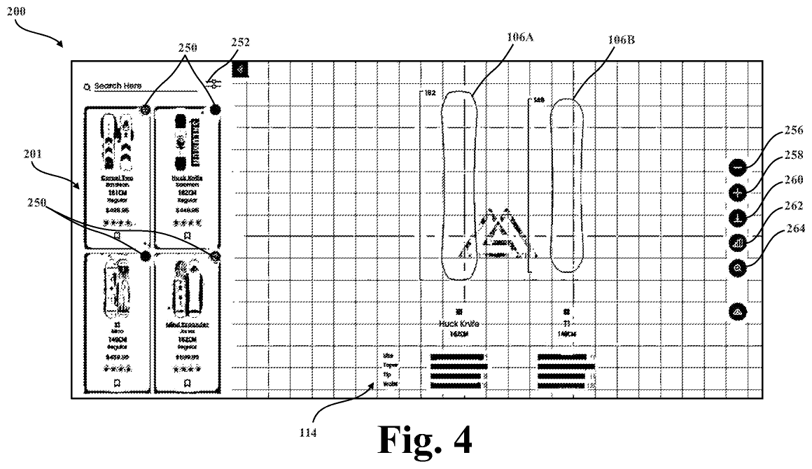

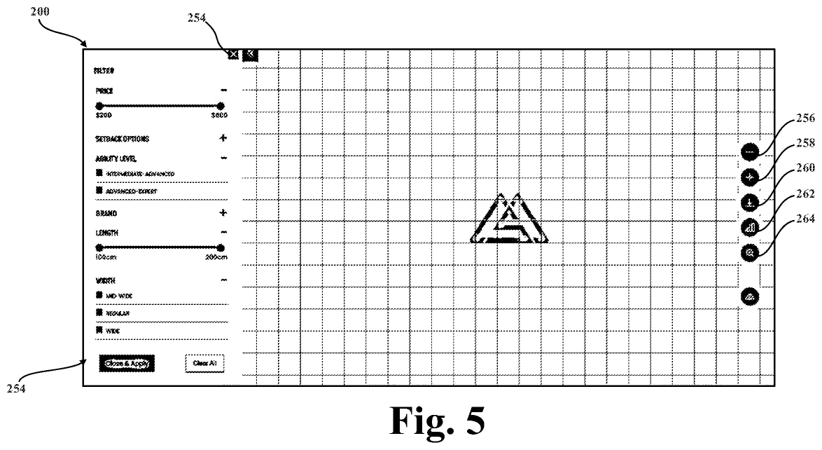

The user interface module 128 may display a list of snowboards 106 to the user 104 in the equipment browser section 202 when in a browsing configuration as shown in FIG. 4 and when in a filtering configuration, discussed with respect to FIG. 5, the user interface module 128 may display a menu in the equipment browsing section 202 for the user to provide input. A user may switch between a browsing configuration and the filtering configuration based on input from the GUI 200, discussed in greater detail below. In the browsing configuration, the GUI 200 displays a list of snowboards 106 that allows the user 104 to browse and search through the snowboards 106 contained therein. Further, the user 104 is able to select snowboards 106 shown in the equipment browser section 202 to add the snowboards 106 for display in the equipment visualizer section 204. The user interface module 128 then generates for display, the shape of the snowboards 106 in a first perspective. The snowboard specification set 114 associated with the snowboard 106 is displayed in the equipment visualizer section 204. This snowboard specification set 114 is received from the sporting equipment specification retrieval module 124 and is generally sent to the user interface module 128 when the user 104 selects the snowboard 106 from the equipment browser section 202 of the GUI 200. Finally, the control manager section 208 contains a number of command buttons (described below) to allow the user 104 to control the various aspects of the GUI 200 such as the equipment visualizer section 204 and the specification viewer section 206. Overall, the GUI 200 assists the user 104 in analyzing and comparing the selected snowboards 106.

Referring to FIG. 4, an example GUI 200 of the sporting equipment system 100 for comparing and analyzing snowboards 106A, 106B is shown. As such, the equipment browser 202 is configured to display images of snowboards 106 for user 104 selection and the equipment visualizer section 204 is configured to display outlines of the snowboards 106 selected by the user 104. The control manager section 208 is also displayed on the right side of the GUI 200. The control manager section 208 may include a perspective button 256 for switching between a top-down perspective and a side perspective, an overlap button 258 to change the display of the snowboards 106 from the side-by-side view to the overlapping view, an alignment button 260 configured to align the shapes of the snowboards 106 to a common line, a specification button 262 configured to switch specification sets 114 displayed in the specification viewer section 206 between a display mode and a hidden mode, and a zoom button 264 configured to change a zoom level of the equipment visualizer section 204. A more detailed description of each of the buttons and functionalities associated with each button will be described below.

The user 104 can choose which snowboards 106 to display in the equipment visualizer section 204 by clicking on a respective selection button 250 located proximate to one or more of the images 201 of the snowboard 106. In addition, the user interface module 128 is configured to display in the specification viewer section 206 at least the size/length, the taper, the tip width, and the waist width of the selected snowboards 106 in response to user selection of the specification button 262. As should be appreciated from FIG. 4, the GUI 200 displays the first snowboard 106A, the second snowboard 106B, and the corresponding snowboard specification sets 114 proximate to the first and second snowboards 106A, 106B.

Referring to FIG. 5, an example GUI 200 of the sporting equipment system 100 for searching through snowboards 106 is shown. The equipment browser section 202 is shown in the filtering configuration. When in the filter configuration, the user interface module 128 displays in the equipment browser section 202 a menu including a number of filtering options to allow the user 104 to limit the snowboards 106 shown in the equipment browser section 202 when in the browsing configuration. After the user 104 applies the desired filters, the user 104 can click on a close button 254 to change the equipment browser section 202 from the filtering configuration back to the browsing configuration. The equipment browser section 202 may include a user recommendation portion which includes the resulting snowboards 106 after filtering and switching back to the browsing configuration.

In the exemplary embodiment shown in FIG. 5, the user interface module 128 displays in the equipment browser section 202 a menu with various selectable options such as a price of the snowboard 106, a setback of the snowboard 106, an ability level of the user 104, a brand of snowboard 106, a length of the snowboard 106, and a width of the snowboard 106. The options displayed by the equipment browser in FIG. 5 are meant for filtering/searching through snowboards 106, and the options may be different so as to match a different type of snowboard 106. For example, if the user 104 were to use the sporting equipment system 100 for surfboards instead of snowboards 106, the filtering could include a volume of the board. Other options are contemplated.

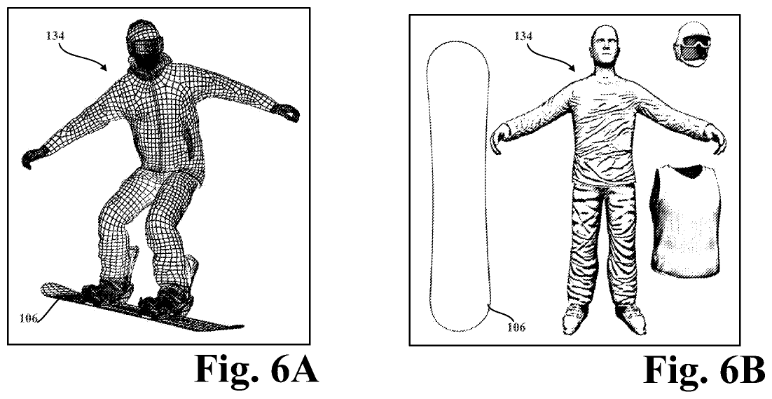

Referring to FIGS. 6A-6B, the three-dimensional rider avatar module 130 is shown in two positions relative to the snowboard 106. In FIG. 6A, the rider avatar 134 is shown in the riding pose on top of the snowboard 106. As described above, the rider avatar module 130 generates the rider avatar 134 for display in the equipment visualizer section 204 in response to input from the user 104 indicating characteristics such as height and weight. The three-dimensional sporting equipment rendering module 126 generates a three-dimensional model of the snowboard 106 for display in the equipment visualizer section 204. Since it can be useful to see how the snowboard 106 looks relative to the user 104 in various positions, the user interface module 128 may also show the rider avatar 134 positioned next to snowboard 106 in the equipment visualizer section 204, such as is shown in FIG. 6B.

Alternatively, although not depicted by the figures, the rider avatar 134 and the model of the snowboard 106 may be shown in various other positions. The model of the snowboard 106 may be shown on a ski slope or snowy hill along with the rider avatar 134 in the riding pose. This way, the user 104 may see what they may look like while riding the snowboard 106 down a ski slope/snowy hill.

In addition to displaying the rider avatar 134 and the model of the snowboard 106 in various positions, the three-dimensional sporting equipment rendering module 126 may further calculate and/or generate for display the expected load applied to the model of the snowboard 106 when the rider avatar 134 is in the riding pose atop the snowboard 106. For example, the three-dimensional sporting equipment rendering module 126 may generate for display a force diagram depicting force arrows drawn relative to the model of the snowboard 106 and meant to depict the force of the rider avatar 134 (i.e. the user 104) on the snowboard 106 while riding. For example, the force diagrams may be similar to the force diagrams shown and described in U.S. Pat. No. 9,526,970, the content of which is hereby incorporated by reference in its entirety. The three-dimensional sporting equipment rendering module 126 may also calculate and/or display axial stiffness and torsional stiffness curves. The axial stiffness curve illustrates the axial stiffness of the snowboard 106 based on the distance from the board center. Similarly, the torsional stiffness curve illustrates the torsional stiffness of the snowboard 106 based on the distance from the equipment center. These curves can help the user 104 determine the expected response from the snowboard 106 when ridden with a certain stance.

Further, the user interface module 128 may display other metrics for the snowboard 106 in the equipment visualizer section 204. For example, the other metrics may include values for a hardness, a rigidity, a material type, a layering, a durability, a porosity, a weight, a density, a volume, a surface area, a taper, and/or a setback of the snowboard 106. Even further, the user interface module 128 may display in the equipment visualizer section 204, an indication of the contour of the snowboard 106. The user interface module 128 may display in the equipment visualizer section 204 a diagram of the snowboard 106 that indicates whether the snowboard 106 is a cambered board (e.g., board has four contact points with the snow near the tip and the tail and arches up at the center between the bindings) or a rocker board (e.g., the nose and the tail form a banana shape and the board has contact points with the snow in the center of the board) or a combination of the two (e.g., the board has some sections which are camber and some sections which are rocker). Dynamic metrics may also be displayed in the equipment visualizer section 204. For example, continuing with the snowboard 106 example, the equipment visualizer section 204 may display what the snowboard 106 would look like when on an edge (e.g. force diagrams). Other dynamic metrics, such as an expected turning radius, ease of turn initiation, speed characteristics, float characteristics, aggression characteristics, butterability, chunderability, and impact absorption are contemplated. Other measurements, diagrams, and/or metrics are contemplated.

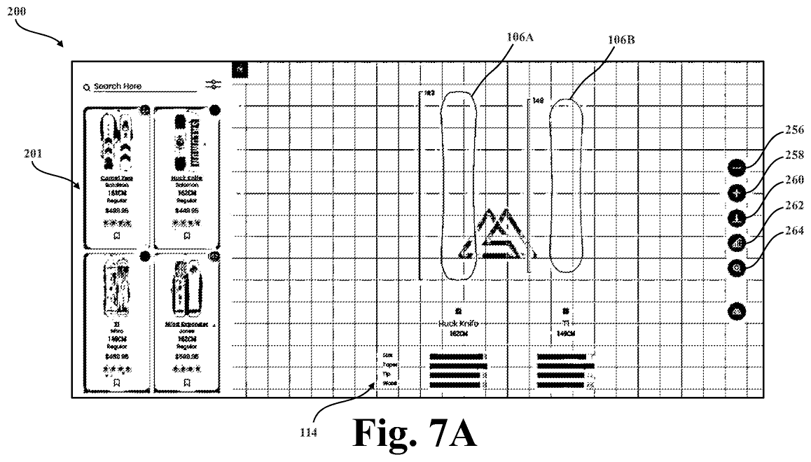

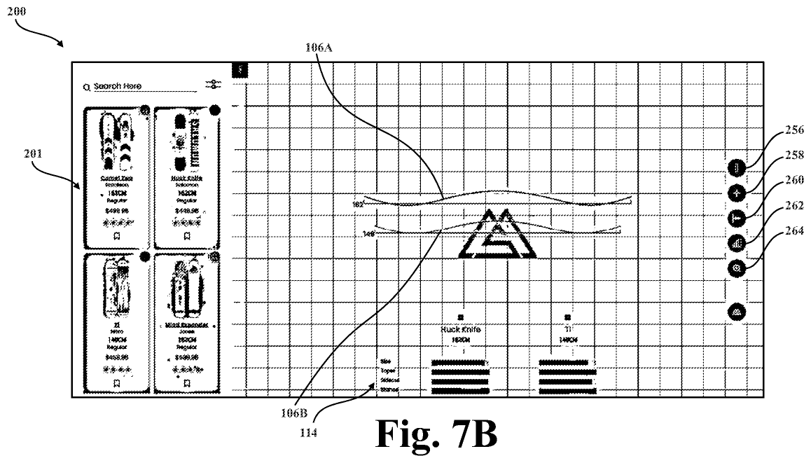

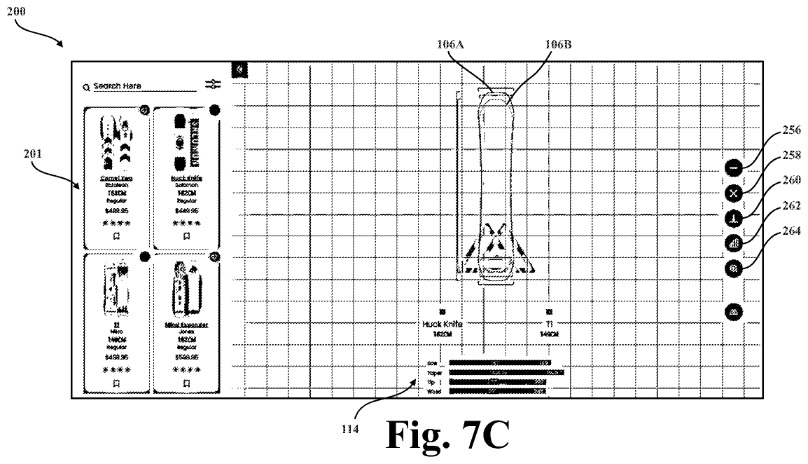

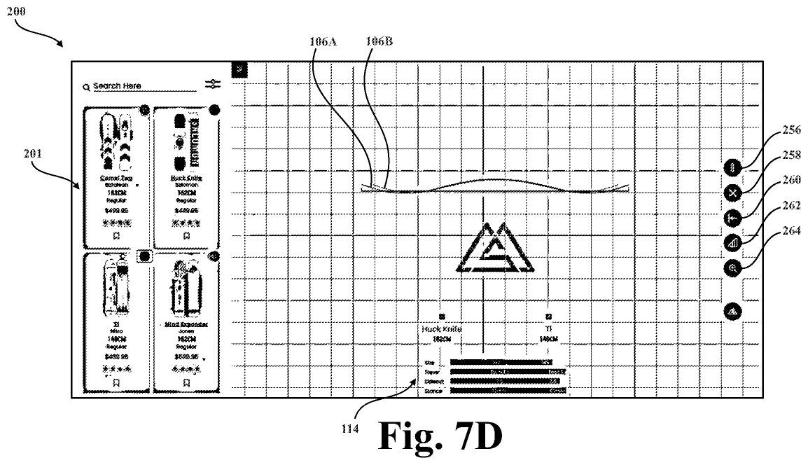

Referring to FIGS. 7A-7D, the graphical user interface 200 of the sporting equipment system 100 is shown displaying the first snowboard 106A and the second snowboard 106B in various positions and from various perspectives. Showing the first and second snowboards 106A, 106B in these different positions/perspectives helps the user 104 make relative comparisons between the first and second snowboards 106A, 106B and recognize the differences between the first and second snowboards 106A, 106B. As can be appreciated from the figures, the differences between the first and second snowboards 106A, 106B can be minimal and difficult to recognize. Displaying the first and second snowboards 106A, 106B in the different positions/perspectives makes it easier for the user 104 to notice the distinctions and to make an informed selection as to which one of the first or second snowboards 106A, 106B better matches the preferences of the user 104.

In FIG. 7A, the first and second snowboards 106A, 106B are shown proximate to one another and from a top-down perspective. The top-down perspective exemplifies the outlines of the first and second snowboards 106A, 106B such that the overall lengths and shapes of the snowboards 106A, 106B can be compared side-by-side in the side-perspective. The user may select the perspective button 256 to switch between the top-down perspective and the side perspective.

In FIG. 7B, the first and second snowboards 106A, 106B are shown proximate to one another and in the side perspective. In the illustrated embodiment, the side-by-side view perspective is perpendicular to the top-down perspective. When shown from the side perspective, the lengths and side profiles of the first and second snowboards 106A, 106B are more easily compared and analyzed by the user 104. The perspective button 256 may also be used to switch back to the top-down perspective from the side perspective. It is further contemplated to allow the user 104 to switch between any number of perspectives relative to the first and second snowboards 106A, 106B.

In FIGS. 7C-7D, the first and second snowboards 106A, 106B are shown in an overlapping view and from the top-down and side perspectives, respectively. The overlapping views further exemplify the differences between the first and second snowboards 106A, 106B that may not be readily apparent from the views shown in FIGS. 7A-7B. The user may select the overlap button 258 to change the display of the first and second snowboards 106A, 106B from the top-down and side perspectives of FIG. 7A-7B to the overlapping view of FIGS. 7C-7D.

The user 104 may select the alignment button 260 to align the shapes of the first and second snowboards 106A, 106B to a common line. For example, the common line may include at least one of a vertical line and a horizontal line. The figures show a series of gridlines, which may act as the common line. If the first and second snowboards 106A, 106B are being shown from the top-down perspective like in FIG. 7A, the lower end of each of the first and second snowboards 106A, 106B may be moved to align with a common horizontal line. If the first and second snowboards 106A, 106B are being instead shown from the side perspective like in FIG. 7B, the left end of each snowboard 106A, 106B may be moved to align with a common vertical line. These alignments may make it easier for the user 104 to appreciate the differences in length and profile of the snowboards 106.

The user 104 may provide input to the specification button 262 so that the user interface module 128 displays the snowboard specification sets 114 retrieved by the sporting equipment specification retrieval module 124 in the specification viewer section 206 in a display mode or a hidden mode. In the figures, the snowboard specification sets 114 are shown in the displayed mode. In the hidden mode, the snowboard specification sets 114 are not displayed.

Even further, the user 104 may provide input to the zoom button 264 to change a zoom level of the equipment visualizer section 204. Although not shown in the figures, the first and second snowboards 106A, 106B may be viewed as if the user 104 were closer to or further away from the snowboards 106. The zoom button 264 may switch the equipment visualizer section 204 between two discrete zoom levels. Alternatively, the zoom button 264 may include a sliding zoom scale which allows the user 104 to view the snowboards 106 from any zoom level between a maximum zoom level and a minimum zoom level.

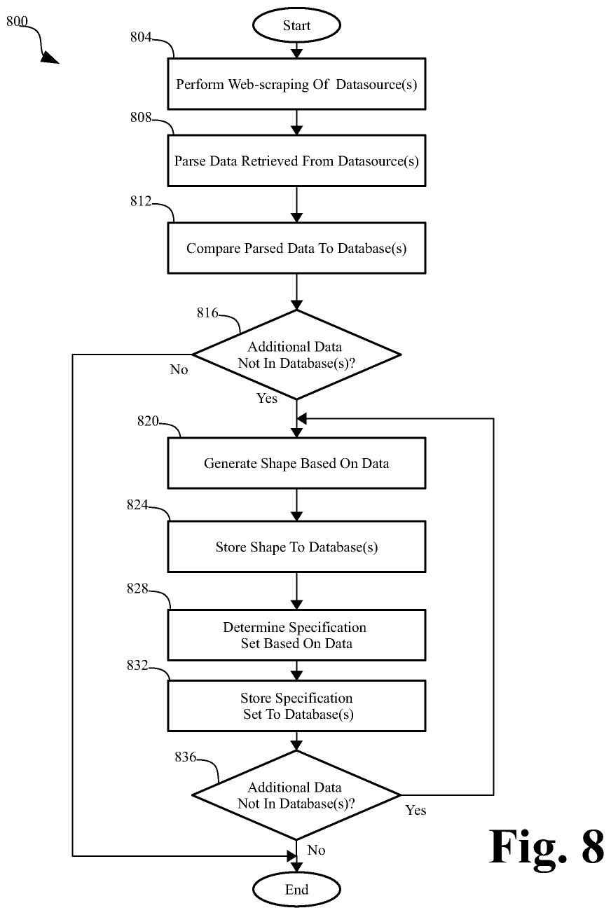

Referring to FIGS. 8-10, three flowcharts illustrating methods of implementing the sporting equipment system 100 are shown. As will be appreciated from the subsequent description below, the methods merely represent exemplary and non-limiting flowcharts that describe particular methods for implementing the sporting equipment system 100. The methods are in no way intended to serve as complete methods or catchall methods for implementing the sporting equipment system 100.

As shown by FIG. 8, an example method 800 for generating a new snowboard entry for the sporting equipment system begins at 804. At 804, the method 800 performs web-scraping of one or more data sources and the method continues to 808. For example, the web scraping may be performed as noted above. At 808, the method 800 parses the data retrieved from one or more data sources and then continues to 812 in order to compare the parsed data against the data stored on the database 108. After comparing the data in 812, the method 800 move to 816 and determines whether there is additional data retrieved from the one or more data sources that is not stored in the database 108. For example, if additional data is retrieved that is not presently stored in the database 108, a snowboard manufacturer has added a new snowboard to its product offerings. If at 816, the method 800 determines that there is additional data retrieved from the one or more data sources, the method 800 continues at 820; otherwise, the method 800 may end. At 820, the method 800 generates a shape based on data retrieved from the one or more data sources. For example, the method 800 may generate a shape of the snowboard 106. At 824, the method 800 may store the shape to the database 108.

At 828, the method 800 may determine a specification set 114 based on the data retrieved. For example, the specification set 114 may include a measurement of: the length of the snowboard, the taper of the snowboard, the tip of the snowboard, the waist of the snowboard, or other measurements identified above. At 832, the method 800 may store the specification set 114 to the database 108.

At 836, the method 800 determines whether there is additional data retrieved from the one or more data sources that is not stored in the database 108. If so, the method 800 continues back at 820; otherwise, the method 800 may end. Steps 820 through 836 are performed until there is no additional data from the data retrieved from the one or more data sources that has not been entered into the one or more data sources; otherwise, the method 800 may end.

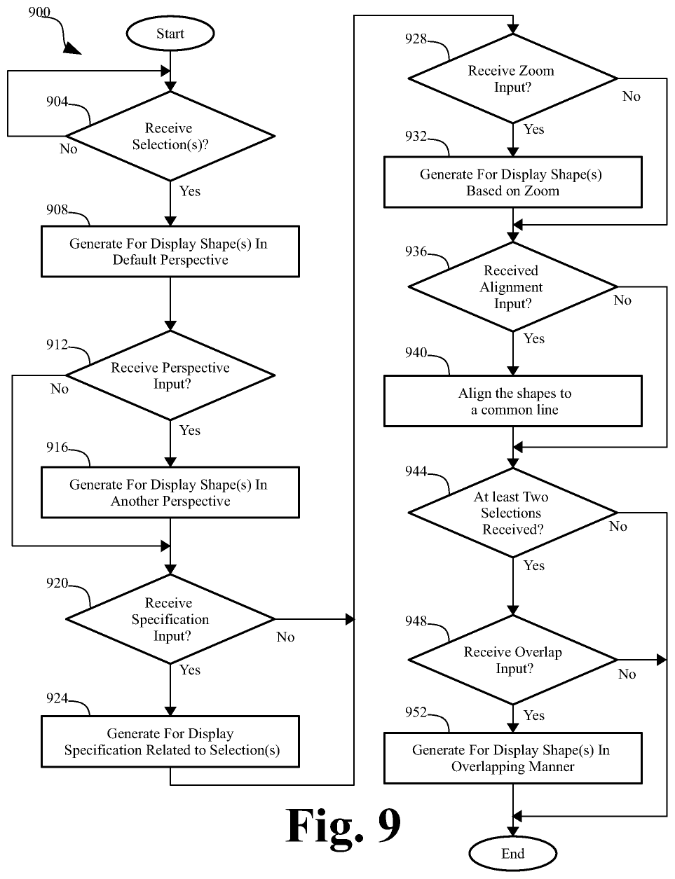

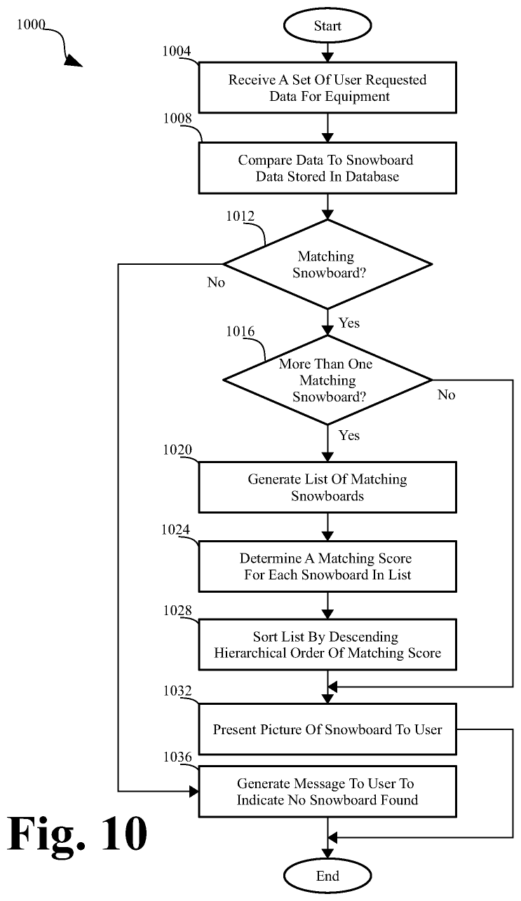

As shown by FIG. 9, an example method 900 for displaying the snowboard 106 with the sporting equipment system 100 begins at 904. At 904, the method 900 waits for the user 104 to input a selection of a snowboard 106. Once the selection is received by the user interface module 128, the method continues to 908 at which point the method 900 generates for display the shapes of the selected snowboards 106 in the first perspective. The first perspective may be the top-down perspective noted above, or it may be a different perspective (e.g., the side perspective).

At 912, the method 900 determines whether input was received by the user 104 to the perspective button 256. If yes, the method 900 continues at 916 where the method 900 generates for display the shapes of the selected snowboards 106 in a second perspective, different from the first perspective; otherwise, the method may continue at 920. In some embodiments, the second perspective is perpendicular to the first perspective. For example, the second perspective may be the side perspective if the first perspective was the top-down perspective. At 920, the method 900 determines whether input was received by the user 104 to the specification button 262. If yes, the method 900 continues to 924; otherwise, the method 900 continues at 928. At 924, the method 900 displays the snowboard specification sets 114 (e.g., switches the specification sets 114 from hidden mode to display mode).

At 928, the method 900 determines whether input was received to the zoom button 264. If yes, the method 900 continues to 932; otherwise, the method 900 continues at 936. At 932, the method 900 displays the shapes of the snowboards 106 based on the selected zoom level. At 936, the method 900 determines whether input was received by the alignment button 260. If so, the method 900 continues to 940; otherwise, the method continues at 944. At 940, the method 900 aligns the shapes of the snowboards 106 to a common line. For example, if the shapes of the snowboards 106 are being shown from the top-down perspective, the user interface module 128 may bring the lower end of each shape down to a common horizontal line such that the length of the snowboards 106 can be more easily compared by the user 104. Alternatively, if the shapes of the snowboards 106 are being shown from the side perspective, the user interface module 128 may bring the left end of each shape over to a common vertical line. After the shapes are aligned, or if no alignment input was received, the method 900 continues to 944. It will be appreciated that it is also possible to align only a single shape to the common line.

At 944, the method 900 determines whether the user 104 selected more than one snowboard 106 at step 904. If only one selection was made, the method 900 ends. If at least two selections were made, however, the method 900 continues to 948. At 948, the method 900 determines whether input was received to the overlap button 258. If so, the method 900 continues to 952; otherwise, the method 900 may end. At 952, the method 900 generates for display, the shapes of the snowboards 106 in an overlapping manner. For example, if the user 104 selected the first and second snowboards 106A, 106B, the shape of the second snowboard 106B may be moved over top of the shape of the first snowboard 106A (or vice versa). In this view, the user 104 may find it easier to compare any distinctions between the first and second snowboards 106A, 106B.

As shown by FIG. 10, an example method 1000 for searching/filtering through snowboards 106 stored on the database 108 begins at 1004. At 1004, the method 1000 receives a set of user requested data. The set of user requested data may, for example, be received by the user interface module 128 when the equipment browser section 202 is in the filtering configuration as noted above. After the user requested data is received, the method 1000 continues to 1008 in order to compare the user requested data against the snowboards 106 stored on the database 108. After performing the comparison, the method 1000 continues to 1012.

At 1012, the method 1000 determines if snowboards 106 stored on the database 108 match the user requested data. If so, the method 1000 continues to 1016; otherwise, the method 1000 may continue at 1036. At 1016, the method 1000 then determines if more than one snowboard 106 was uncovered during 1008. If so, the method 1000 continues to 1020; otherwise, the method 1000 continues at 1032. At 1020, the method 1000 generates a list of the matching snowboards 106. After generating the list, the method 1000 moves to 1024 and scores each snowboard 106 based on the comparison at 1008. In some embodiments, the method 1000 assigns a matching score for each snowboard 106 calculated based on the set of user requested data sent to the user interface module 128 by the user 104 via the equipment browser section 202. After each matching snowboard 106 is scored at 1024, the method 1000 continues to 1028.

At 1028, the method 1000 sorts each snowboard 106 based on the matching scores determined at 1024. In the illustrated embodiment, the method 1000 sorts the matching snowboards 106 in descending hierarchical order based on the matching scores. It is further contemplated to sort the matching snowboards 106 in other orders. For example, in ascending hierarchical order or any other order that assists the user 104 in parsing through the matching snowboards 106. After the matching snowboards 106 are sorted, the method 1000 goes to 1032 in order to present pictures/images of the matching snowboards 106 to the user 104 according to the descending hierarchical order.

Referring back to 1012, if no matching snowboards 106 are found during the comparison at 1008, the method 1000 instead moves to 1036 and generates a message to inform the user 104 that no matching snowboards 106 were found. Alternatively, if only one matching snowboard 106 was found, the method 1000 moves from 1012, to 1016, and then to 1032. Since only one matching snowboard 106 was found, it is not necessary to score and/or sort the matching snowboards 106. As such, the method 1000 moves to 1032 and presents a picture/image of the single snowboard 106. After 1032 or 1036, the method 1000 ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems, apparatuses, and/or methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTMLS (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A sporting equipment apparatus for comparing data sets, the sporting equipment apparatus comprising:
a sporting equipment data aggregation module configured to receive a plurality of data sets for a plurality of pieces of sporting equipment, each set of the plurality of data sets including sporting equipment parameters for a piece of sporting equipment of the plurality of pieces of sporting equipment;
a user interface module configured to receive input of a user requested data set including one or more requested sporting equipment parameters; and
a sporting equipment analysis module configured to:
compare the user requested data set to the plurality of data sets; and
select at least one piece of sporting equipment from the plurality of pieces of sporting equipment based on a comparison of the user requested data set to the plurality of data sets; and
wherein the user interface module is configured to generate for display at least one image of the at least one piece of sporting equipment presented to a user.

2. The sporting equipment apparatus of claim 1, wherein the user interface module is configured to generate for display the at least one image of the at least one piece of sporting equipment via a graphical user interface, the graphical user interface including a plurality of sections including an equipment visualizer, a specification viewer, an equipment browser, and a control manager.

3. The sporting equipment apparatus of claim 2, wherein the at least one piece of sporting equipment is further defined as a first piece of sporting equipment, the at least one image of the at least one piece of sporting equipment is further defined as a first picture, the sporting equipment analysis module is configured to select a second piece of sporting equipment and a third piece of sporting equipment based on the comparison of the user requested data set to the plurality of data sets.

4. The sporting equipment apparatus of claim 3, wherein the user interface module is configured to generate for display the first picture of the first piece of sporting equipment, a second picture of the second piece of sporting equipment, and a third picture of the third piece of sporting equipment in the equipment browser.

5. The sporting equipment apparatus of claim 4, wherein the user interface module is configured to generate for display the first picture of the first piece of sporting equipment, the second picture of the second piece of sporting equipment, and the third picture of the third piece of sporting equipment in the equipment browser in a hierarchal order.

6. The sporting equipment apparatus of claim 5, wherein the hierarchal order is a descending hierarchal order in which the sporting equipment analysis module determines the descending hierarchal order based on a number of matching parameters for each of the first piece of sporting equipment, the second piece of sporting equipment, and the third piece of sporting equipment.

7. The sporting equipment apparatus of claim 3, wherein the user interface module is configured to generate for display in the equipment visualizer, a first shape of the first piece of sporting equipment in a first perspective or a second perspective in response to receiving a selection of the first piece of sporting equipment from the equipment browser.

8. The sporting equipment apparatus of claim 8, wherein the user interface module is configured to generate for display in the equipment visualizer, a second shape of the second piece of sporting equipment in the first perspective or the second perspective in response to receiving a selection of the second piece of sporting equipment from the equipment browser.

9. The sporting equipment apparatus of claim 8, wherein the user interface module is configured to concurrently generate for display in the equipment visualizer, the first shape of the first piece of sporting equipment in the first perspective or the second perspective in response to receiving the selection of the first piece of sporting equipment from the equipment browser and the second shape of the second piece of sporting equipment in the first perspective or the second perspective in response to receiving the selection of the second piece of sporting equipment from the equipment browser.

10. The sporting equipment apparatus of claim 8, wherein the user interface module is further configured to in response to user input, generate for display in the equipment visualizer, the first shape and the second shape in a collapsible view in at least one of the first perspective and the second perspective as to allow the user to make a relative comparison of the first shape and the second shape to each other in at least one of the first perspective and the second perspective.

11. The sporting equipment apparatus of claim 10, wherein in the collapsible view the first shape and the second shape are displayed overlapping each other.

12. The sporting equipment apparatus of claim 1, wherein the one or more requested sporting equipment parameters includes at least one of a turning radius, an aggression, a turn initiation, a speed, a float, a butterability, a carvability, a chunderability, and an impact absorption.

13. A method for comparing data sets for sports equipment, the method comprising:
receiving a plurality of data sets for a plurality of pieces of sporting equipment, each set of the plurality of data sets including sporting equipment parameters for a piece of sporting equipment of the plurality of pieces of sporting equipment;
receiving input of a user requested data set including one or more requested sporting equipment parameters; and
compare the user requested data set to the plurality of data sets; and
selecting at least one piece of sporting equipment from the plurality of pieces of sporting equipment based on a comparison of the user requested data set to the plurality of data sets; and
generating for display at least one image of the at least one piece of sporting equipment presented to a user by way of a graphical user interface.

14. The method of claim 13, wherein the graphical user interface including a plurality of sections including an equipment visualizer, a specification viewer, an equipment browser, and a control manager.

15. The method of claim 14, wherein the at least one piece of sporting equipment is further defined as a first piece of sporting equipment, the at least one image of the at least one piece of sporting equipment is further defined as a first picture, the method further comprising selecting a second piece of sporting equipment and a third piece of sporting equipment based on the comparison of the user requested data set to the plurality of data sets.

16. The method of claim 15, further comprising generating for display the first picture of the first piece of sporting equipment, a second picture of the second piece of sporting equipment, and a third picture of the third piece of sporting equipment in the equipment browser.

17. The method of claim 16, further comprising generating for display the first picture of the first piece of sporting equipment, the second picture of the second piece of sporting equipment, and the third picture of the third piece of sporting equipment in the equipment browser in a hierarchal order.

18. The method of claim 17, wherein the hierarchal order is a descending hierarchal order, the method further comprising determining the descending hierarchal order based on a number of matching parameters for each of the first piece of sporting equipment, the second piece of sporting equipment, and the third piece of sporting equipment.

19. The method of claim 14, further comprising generating for display in the equipment visualizer, a first shape of the first piece of sporting equipment in a first perspective or a second perspective in response to receiving a selection of the first piece of sporting equipment from the equipment browser.

20. A non-transitory computer-readable medium storing processor-executable instructions, the processor-executable instructions comprising:
receiving a plurality of data sets for a plurality of pieces of sporting equipment, each set of the plurality of data sets including sporting equipment parameters for a piece of sporting equipment of the plurality of pieces of sporting equipment;
receiving input of a user requested data set including one or more requested sporting equipment parameters; and
comparing the user requested data set to the plurality of data sets; and
selecting at least one piece of sporting equipment from the plurality of pieces of sporting equipment based on a comparison of the user requested data set to the plurality of data sets; and
generating for display at least one image of the at least one piece of sporting equipment presented to a user by way of a graphical user interface.
